(19) United States
(12) Patent Application Publication
(10) Pub. No.: US 2001/0053645 A1
(43) Pub. Date: Dec. 20, 2001

(54) Multi-layered ballistic resistant article

(76) Inventor: William J. Henderson, Cameron, NC (US)

Correspondence Address: NEEDLE & ROSENBERG, P.C., Suite 1200, The Candler Building, 127 Peachtree Street, N.E., Atlanta, GA, 30303-1811, US

(21) Appl. No.: 09/765,053

(22) Filed: Jan. 18, 2001

Related U.S. Application Data
(60) Provisional application No. 60/177,045, filed on Jan. 18, 2000.

(51) Int. Cl. F41H 1/02; F41H 1/04; B32B 5/02; B32B 27/04; B32B 27/12; D03D 15/00; D03D 25/00; B32B 5/26

(52) U.S. Cl. 442/135; 442/181; 442/239; 2/2.5; 428/911

(57) ABSTRACT

An embodiment of the present invention described and shown in the specification and drawings is a ballistic resistant article including at least one layer of hard armor and at least one layer of fibrous armor composite. Each fibrous armor composite layer includes two or more layers of a fibrous ply, each fibrous ply having a plurality of unidirectional oriented fibers. When the layers of plies are aligned to form the composite, the fibers in adjacent fibrous plies are arranged at an acute angle to each other. It is emphasized that this abstract is provided to comply with the rules requiring an abstract which will allow a searcher or other reader to quickly ascertain the subject matter of the technical disclosure. It is submitted with the understanding that it will not be used to interpret or limit the scope or meaning of the claims. 37 C.F.R. § 1.72(b).

### BACKGROUND OF THE INVENTION

This invention relates to ballistic resistant articles and constructions. More particularly, this invention relates to a ballistic resistant article having improved ballistic protection formed from a fibrous armor composite layer and a hard armor layer.

### SUMMARY

The present invention relates to ballistic resistant articles formed from at least one layer of fibrous armor composite and at least one layer of hard armor. Each fibrous armor composite layer of the ballistic resistant article has two or more fibrous plies. Each ply has a plurality of unidirectional oriented fibers generally in a fibrous network. A surface of one fibrous ply is in contact with and at least partially bound to the surface of one adjacent fibrous ply so that, when adjacent plies are aligned to form the composite, at least one network of unidirectional oriented fibers within each of the adjacent fibrous plies is at an acute angle to each other. A surface of the composite is connected to a surface of the layer of hard armor to form a generally monolithic impact resistant article.

The present invention provides a ballistic resistant article which provides enhanced ballistic protection as compared to conventional plies or composites of plies attached to hard armor members. Because of the enhanced capability of the fibrous armor composite of the present invention, the composite can be used, for example, to construct ballistic resistant articles that are lighter while still providing comparable, and in some cases superior, ballistic protection than conventional composites formed from the same conventional plies or fibers. Further, the fibrous armor composite can be used to construct ballistic resistant articles which are substantially thinner but which also exhibit comparable, and in some cases, superior ballistic protection to articles formed from conventional composites using the same fibrous plies.

### DETAILED DESCRIPTION OF THE DRAWINGS

The accompanying drawings, which are incorporated in and constitute a part of this specification, illustrate several embodiments of the invention and together with the description, serve to explain the principals of the invention.

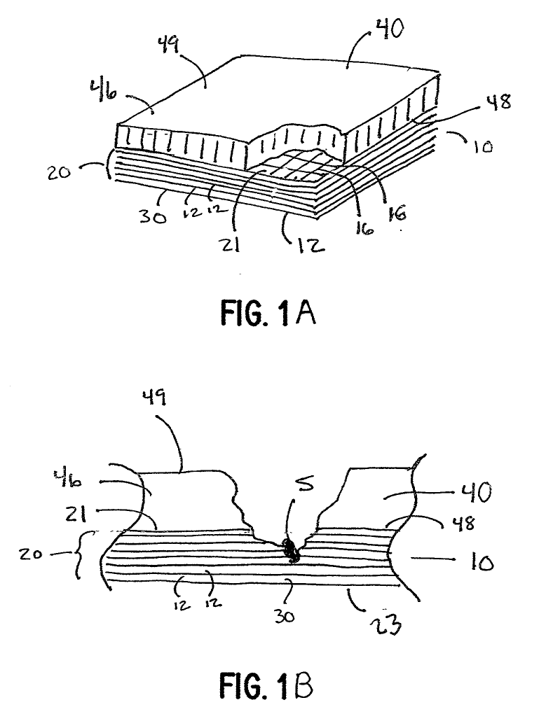

FIG. 1A is a perspective partial cross-sectional view of a ballistic resistant article embodiment of the present invention having a fibrous armor composite bonded to, and overlying, a hard armor layer.

FIG. 1B is a cross-sectional view of the ballistic resistant article shown in FIG. 1A after impact of a projectile on to the exterior surface of the ballistic resistant article.

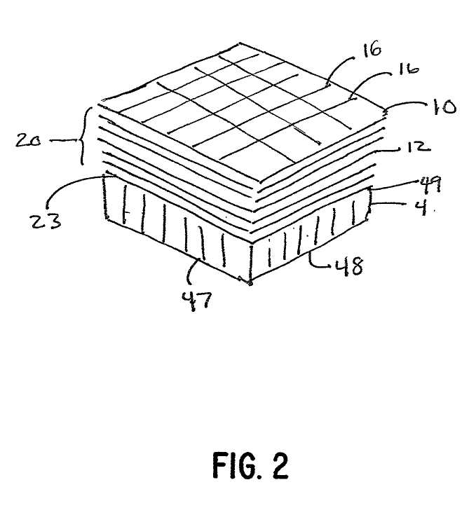

FIG. 2 is a perspective partial cross-sectional view of a ballistic resistant article embodiment of the present invention having a fibrous armor composite bonded to, and underlying, a hard armor layer.

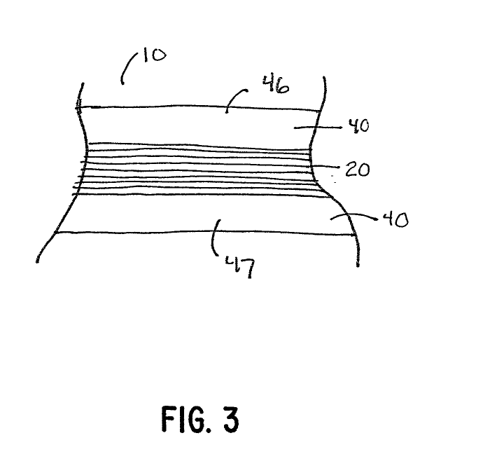

FIG. 3 is a partial cross-sectional view of a ballistic resistant article embodiment of the present invention having a fibrous armor composite bonded to two hard armor layers.

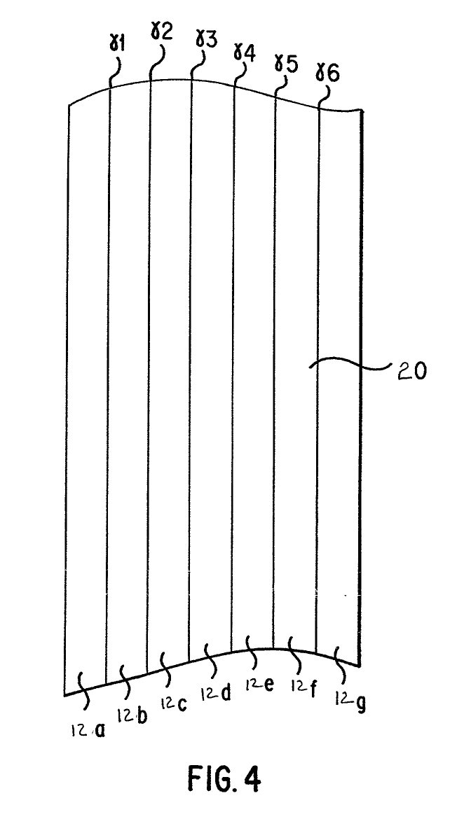

FIG. 4 is a partial side view of an exemplified fibrous armor composite including multiple layers of connected plies.

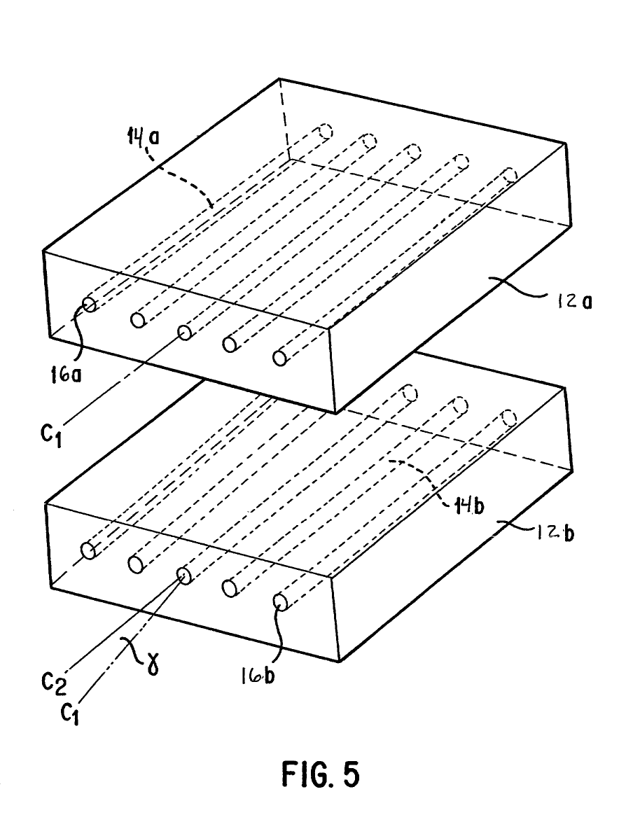

FIG. 5 is an exploded view of two exemplified plies of the fibrous armor composite arranged so that the unidirectional fibers within one ply are at an angle γ less than 45° to the unidirectional fibers within the adjacent ply.

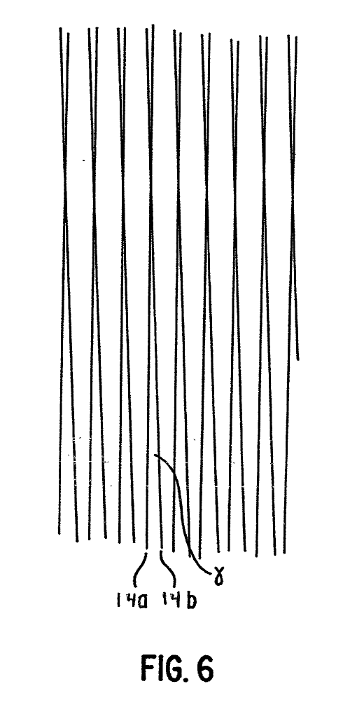

FIG. 6 is a top view of the two plies in the embodiment of FIG. 5.

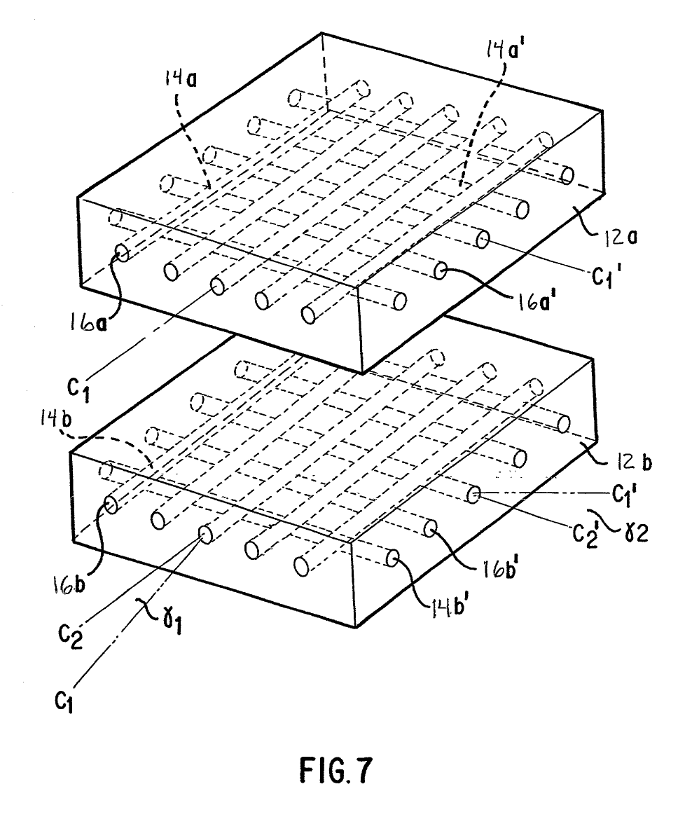

FIG. 7 is an exploded view of two exemplified plies of the fibrous armor composite, each ply having a pair of fibrous networks oriented at about 90° to each other, the plies arranged so that the unidirectional fibers within one ply are at an angle γ less than 45° to the unidirectional fibers within the adjacent ply.

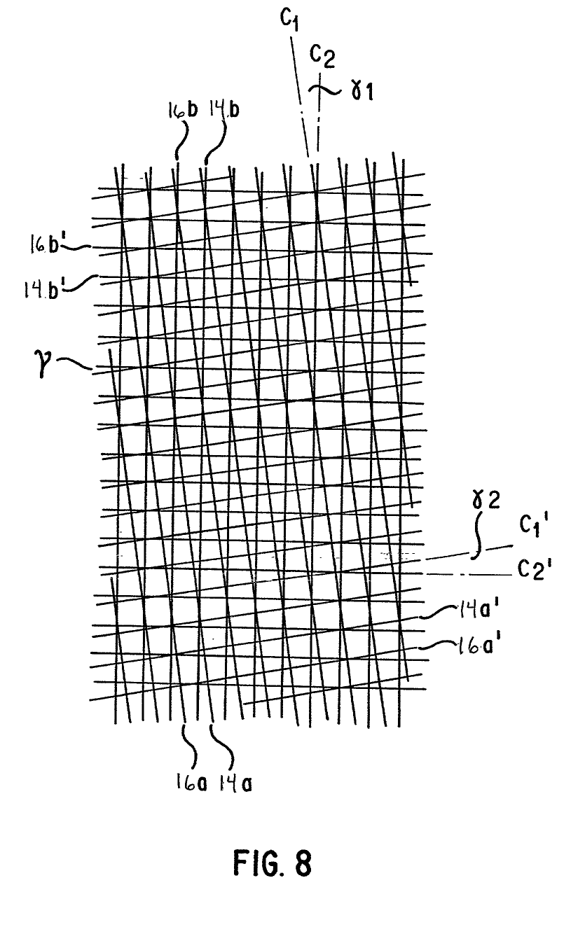

FIG. 8 is a top view of the two plies in the embodiment of FIG. 7.

### DETAILED DESCRIPTION OF THE INVENTION

The present invention is more particularly described in the following examples that are intended as illustrative only since numerous modifications and variations therein will be apparent to those skilled in the art. Thus, the embodiments of this invention described and illustrated herein are not intended to be exhaustive or to limit the invention to the precise form disclosed. They are chosen to describe or to best explain the principles of the invention and its application and practical use to thereby enable others skilled in the art to use the invention. As used in the specification and in the claims, “a” can mean one or more, depending upon the context in which it is used. “Angle” refers to an angle greater than 0° unless otherwise restricted.

Referring to FIGS. 1A-3, the invention is directed to a ballistic resistant article 10 having at least one layer of hard armor 40 and at least one layer of fibrous armor composite 20. Here, the ballistic resistant article 10 is formed from at least two layers or plies 12 of a fibrous anti-ballistic material 30 bonded together to form a layer of the fibrous armor composite 20 which is, in turn, bonded to at least one layer of hard armor 40.

As described in more detail below in reference to FIGS. 4-8, the fibrous armor composite 20 is formed from the bonding of at least two layers or plies 12 of the fibrous anti-ballistic material 20 arranged such that at least one of the uni-directional fibers or filaments 16 within a ply 12 of the fibrous anti-ballistic material 20 is angularly offset with respect to at least one of the uni-directional fibers or filaments 16 in the fibrous anti-ballistic material 20 of an adjoining ply 12. The angular offset between the fibers 16 of adjacent plies 12 is an acute angle, preferably, the acute angle is 45° or less. By maintaining the angular offset at the preferred acute angle between the respective plies 12, the fibrous armor composite 20 alters a penetrating projectile's trajectory and reduces the projectile's energy. The angularly offset fibers 16 of successive adjoining plies 12 continues to rotate the projectile 5 and dissipate its energy. As one skilled in the art will appreciate, because of its light weight and energy dissipation capabilities, the fibrous armor composite 20 of the present invention can enhance the capability of hard armor when the fibrous armor composite 20 is used in combination with known hard armor materials, i.e., either underlying or overlying the hard armor to form the ballistic resistant article 10.

One advantage of the angularly offset fibers 16 of the multi-layered fibrous armor composite 20 is that the energy transferred from the penetrating projectile 5 is dissipated over a large area of the fibrous armor composite 20. When the projectile 5 strikes the fibrous armor composite 20, energy from the projectile 5 is transferred onto the uni-directional fibers 16 within each ply 12 of the fibrous armor composite 20. That is, the uni-directional fibers 16 of each ply 12 act to radiate the transferred energy along the length of the fibers 16 away from the point of impact. Because of the angular offset of the fibers 16 of each successive ply 12 of the fibrous armor composite 20, a projectile 5 striking the fibrous armor composite 20 will transfer, or radiate, energy along the angularly offset fibers 16 of the successive plies 12 which results in the dispersion of energy over a large surface area of the fibrous armor composite 20.

The fibrous armor composite 20 may be bonded to one or more layers of hard armor 40 to form the ballistic resistant article 10. The hard armor 40 may act as a strike face 46, an armor base 47, or as both a strike face 46 and an armor base 47. It is preferred that the material chosen for the layer of hard armor 40 be light in weight and provide excellent ballistic penetration resistance or energy absorption. The fibrous armor composite 20 may be bonded to the layer of hard armor 40 by conventional means known to one skilled in the art. These bonding means may include, for example, mechanical fasteners, such as stitching, screws, bolts, rivets, and the like, chemical adhesives, and thermal bonding, autoclaving, welding, and the like, or combinations thereof.

The material employed to form the hard armor 40 may vary widely and may be metallic, semi-metallic material, an organic material and/or an inorganic material. Illustrative of such materials are those described in G. S. Brady and H. R. Clauser, Materials Handbook, 12th edition (1986). Materials useful for fabrication of the layer of hard armor 40 include high modulus polymeric materials such as polyamides as for example aramids, nylon-66, nylon-6 and the like; polyesters such as polyethylene terephthalate polybutylene terephthalate, and the like, acetal; polysulfones; polyethersulfones; polyacrylates; acrylonitrile/butadiene/styrene copolymers; poly(amideimide); polycarbonates; polyphenylenesulfides; polyurethanes, polyphenyleneoxides; polyester carbonates; polyesterimides; polyimides; polyetheretherketone; epoxy resins; phenolic resins; polysulfides; silicones; polyacrylates; polyacrylics; polydienes; vinyl ester resins; modified phenolic resins; unsaturated polyester; allylic resins; alkyd resins; melamine and urea resins; polymer alloys and blends of thermoplastics and/or thermosets of the materials described above; and interpenetrating polymer networks such as those of polycyanate ester of a polyol such as the dicyanoester of bisphenol-A and a thermoplastic such as a polysulfone. These materials may be reinforced by high strength fibers such as Kevlau® aramid fibers, Spectra® polyethylene fibers, boron fibers, glass fibers, ceramic fibers, carbon and graphite fibers, and the like.

Useful materials for the hard armor 40 also include metals such as nickel, manganese, tungsten, magnesium, titanium, aluminum and steel plate. Illustrative of useful steels are carbon steels which include mild steels of grades AISI 1005 to AISI 1030, medium-carbon steels of grades AISI 1030 to AISI 1055, high-carbon steels of the grades AISI 1060 to AISI 1095, free-machining steels, low-temperature carbon steels, rail steel, and superplastic steels; high-speed steels such as tungsten steels, molybdenum steels, chromium steels, vanadium steels, and cobalt steels; hot-die steels; low-alloy steels; low-expansion alloys; mold-steel; nitriding steels for example those composed of low-and medium-carbon steels in combination with chromium and aluminum, or nickel, chromium, and aluminum; silicon steel such as transformer steel and silicon-manganese steel; ultrahigh-strength steels such as medium-carbon low alloy steels, chrominum-molybdenum steel, chromium-nickel-molybdenum steel, iron-chromium-molybdenum-cobalt steel, quenched-and-tempered steels, cold-worked high-carbon steel; and stainless steels such as iron-chromium alloys austenitic steels, and choromium-nickel austenitic stainless steels, and chromium-manganese steel. Useful materials also include alloys such as manganese alloys, such as manganese aluminum alloy, manganese bronze alloy; nickel alloys such as, nickel bronze, nickel cast iron alloy, nickel-chromium alloys, nickel-chromium steel alloys, nickel copper alloys, nickel-molydenum iron alloys, nickel-molybdenum steel alloys, nickel-silver alloys, nickel-steel alloys; iron-chromium-molybdenum-cobalt steel alloys; magnesium alloys; aluminum alloys such as those of aluminum alloy 1000 series of commercially pure aluminum, aluminum-manganese alloys of aluminum alloy 300 series, aluminum-magnesium-manganese alloys, aluminum-magnesium alloys, aluminum-copper alloys, aluminum-silicon-magnesium alloys of 6000 series, aluminum-copper-chromium of 7000 series, aluminum casting alloys; aluminum brass alloys and aluminum bronze alloys.

As noted above, an example of an anti-ballistic material is titanium. This material is categorized as having a high material hardness which again can be applied against very high energy projectiles 5 such as rifle bullets. Titanium has a material density in the range of 4.5 g/cm3 and an elastic modulus of 116 Gpa. Titanium is twice as heavy as aluminum but is substantially stronger than steel and is well suited to absorb multiple impacts by rifle or other high energy sources.

Useful material for the layer of hard armor 40 may also include ceramic materials. As used herein, a “ceramic material” is an inorganic material having a hardness of at least about Brinell hardness of 25 or Mohs hardness of 2. Useful ceramic materials may vary widely and include those materials normally used in the fabrication of ceramic armor which function to partially deform the initial impact surface of a projectile or cause the projectile to shatter. Illustrative of such metal and non-metal ceramic materials are those described in C. F. Liable, Ballistic Materials and Penetration Mechanics, Chapters 5-7 (1980) and include single oxides such as aluminum oxide (Al₂O₃), barium oxide (BaO), beryllium oxide (BeO), calcium oxide (CaO), cerium oxide (Ce₂O₃ and CeO₂), chromium oxide (Cr₂ O₃), dysprosium oxide (Dy₂O₃), erbium oxide (Er₂O₃), europium oxide (EuO, Eu₂ O₃, Eu₂O₄ and Eu₁₆O₂₁), gadolinium oxide (Gd₂O₃), hafhium oxide (HfO₂), holmium oxide (Ho₂O₃), lanthanum oxide (La₂O₃), lutetium oxide (Lu₂O₃), magnesium oxide (MgO), neodymium oxide (Nd₂O₃), niobium oxide: (NbO, Nb₂O₃, and NbO₂),(Nb₂ O₅), plutonium oxide (PuO,Pu₂O₃, and PuO₂), praseodymium oxide (PrO₂, Pr₆O₁₁, and Pr₂O₃), promethium oxide (Pm₂O₃), samarium oxide (SmO and Sm₂O₃), scandium oxide (Sc₂O₃), silicon dioxide (SiO₂), strontium oxide (SrO), tantalum oxide (Ta₂O₅), terbium oxide (Tb₂O₃ and Tb₄O₇), thorium oxide (ThO₂), thulium oxide (Tm₂O₃), titanium oxide (TiO, Ti₂O₃, Ti₃O₅ and TiO₂), uranium oxide (UO₂, U₃O₈ and UO₃), vanadium oxide (VO, V₂0₃, VO₂ and V₂O₅), ytterbium oxide (Yb₂ O₃), yttrium oxide (Y₂O₃), and zirconium oxide (ZrO₂). Useful ceramic materials also include boron carbide, zirconium carbide, beryllium carbide, aluminum beride, aluminum carbide, boron carbide, silicon carbide, aluminum carbide, titanium nitride, boron nitride, titanium carbide, titanium diboride, iron carbide, iron nitride, barium titanate, aluminum nitride, titanium niobate, boron carbide, silicon boride, barium titanate, silicon nitride, calcium titanate, tantalum carbide, graphites, tungsten; the ceramic alloys which include cordierite/MAS, lead zirconate titanate/PLZT, alumina-titanium carbide, alumina-zirconia, zirconia-cordierite/ZrMAS; the fiber reinforced ceramics and ceramic alloys; glassy ceramics; as well as other useful materials. Preferred ceramic materials for fabrication of hard armor 40 are aluminum oxide and metal and non metal nitrides, borides and carbides. The most preferred ceramic materials for fabrication of hard armor 40 are boron carbide, aluminum oxide, and titanium diboride.

As noted above, an example of an acceptable ceramic material is boron carbide. Boron carbide is a specialty ceramic with very light weight and high material hardness which can be applied against very high energy projectiles 5 such as rifle bullets. Boron carbide has a material density in the range of 2.52 g/cm3, an elastic modulus of 448 Gpa, and a compressive yield strength in the range of 1400 Gpa. This means that the material is approximately 7% lighter than aluminum but more than twice as hard as steel. Like most ceramics, boron carbide will shatter when subjected to high energy impact. It has historically suffered from a low ability to absorb multiple hits by rifle or other high energy projectiles 5 in actual use, but it is presently superior to any other anti-ballistic material in the level 3 and 4 projection categories under the National Institute of Justice Standard 0101.03.

The size (width and height) of hard armor 40 can also vary widely depending on the use of ballistic resistant article 10. For example, in those instances where article 10 is intended for use in the fabrication of light ballistic resistant composites for use against light armaments, hard armor 40 is generally smaller; conversely where article 10 is intended for use in the fabrication of heavy ballistic resistant articles 10 for use against heavy armaments then the layer of hard armor 40 is generally larger.

Referring to FIGS. 1A and 1B, a layer of hard armor 40 is bonded to, and overlies, the multi-layered fibrous armor composite 20. The interior surface 48 of the hard armor 40 is affixed to the exterior surface 21 of the fibrous armor composite 20 so that the resulting ballistic resistant article construction of hard armor 40 and fibrous armor composite 20 is preferably monolithic. In this embodiment, the hard armor 40 is acting as a strike face 46. When a projectile 5 contacts the hard armor 40 there is a resultant release of kinetic energy and the projectile 5 is slowed or stopped. If the projectile 5 penetrates through the hard armor 40 and impacts the underlying fibrous armor composite 20, any remaining energy contained by the projectile 5 is then completely absorbed by the plies 12 of the angularly displaced anti-ballistic material 30 forming the fibrous armor composite 20. Thus, the hard armor 40 serves to reduce the energy state of the projectile 5 so that the underlying fibrous armor composite 20 may effectively stop the projectile 5. As one skilled in the art will appreciate, multiple layers of the fibrous armor composite 20 and multiple layers of the overlying hard armor 40 may be utilized.

Alternatively, and as shown in FIG. 2, the fibrous armor composite 20 may be bonded to the hard armor 40 so that the fibrous armor composite 20 overlies the hard armor 40. In this embodiment, the interior surface 23 of the fibrous armor composite 20 is bonded to the exterior surface 49 of the underlying hard armor 40. Here, the fibrous armor composite 20 acts as the strike face and serves to preferably completely absorb the energy of a striking projectile 5 so that the projectile 5 does not reach the exterior surface 49 of the hard armor 40 or adversely affect the integrity of the hard armor 40. However, if the projectile 5 reaches the exterior surface 49 of the hard armor 40, the intervening plies 12 of the fibrous armor composite 20 that the projectile 5 would have been required to traverse will reduce the energy state of the projectile 5 to a degree which will cause little to no damage to the integrity of the hard armor 40. As one skilled in the art will appreciate, multiple layers of the fibrous armor composite 20 and multiple layers of the underlying hard armor 40 may be utilized.

The ability of the fibrous armor composite 20 of the present invention to distribute the energy of a projectile 5 strike over a large area is a particular advantage when the underlying hard armor 40 is made of a ceramic material such as boron carbide. As noted above, ceramics, and particular boron carbide, have historically suffered from a low ability to absorb multiple hits by rifle or other high energy projectiles 5 in actual use due to their inherent low capacity to distribute the energy from a point impact which causes the ceramic to fracture or fail after as little as one projectile strike of sufficient energy. When the fibrous armor composite 20 of the present invention overlays a ceramic hard armor 40, the ballistic resistant article 10 can withstand the impact of multiple projectile impacts, any one of which would cause a failure of an otherwise unprotected ceramic hard armor 40, without fracture or failure of the underlying ceramic hard armor 40.

Referring now to FIG. 3, the ballistic resistant article 10 may comprise at least one layer of a hard armor 40, to act as a strike face 46, bonded to at least one layer of fibrous armor composite 20 which is, in turn, bonded to at least one layer of a hard armor 40 which acts as an armor base 47. In this way, various combinations of hard armor plate material may be chosen to increase the penetration resistance of the ballistic resistant article 10. For example, a titanium hard armor 40 may be chosen as the strike face 46 and, for weight considerations, a ceramic hard armor 40 may be chosen as the armor base 47.

As shown in FIGS. 4-8, the multilayer fibrous armor composite 20 is formed from two or more layers of the fibrous plies 12. Each fibrous ply 12 has at least one fibrous network 14 which has a plurality of unidirectional oriented fibers 16. The fibers 16 are arranged so that the plurality of unidirectional oriented fibers are substantially parallel to one another along a common fiber direction C. It is preferred that the plurality of unidirectional oriented fibers be arranged in a sheet-like array and aligned parallel to one another along the common fiber direction C.

Referring to FIGS. 4 and 5, an exemplified fibrous armor composite 20 is shown comprised of 7 stacked layers of fibrous plies 12a, 12b, 12c, 12d, 12e, 12f, and 12g. The layers of plies 12a-12g of the composite 20 are arranged so that, with adjacent plies 12 aligned, the fibers 16 within one fibrous network 14 of oriented fibers 16 of one ply 12 are arranged at an angle γ less than 45° to the fibers 16 of one fibrous network 14 of oriented fibers of the adjacent ply 12.

The value of the angle γ has a significant effect on the ballistic protection provided by the fibrous armor composite 20 and thus on the ballistic protection provided by the ballistic resistant article 10. In general, the more acute the angle γ, the further the angle γ diverges from 45°, the greater the ballistic protection provided, and conversely, the less acute the angle γ, the closer the angle γ approaches 45°, the less ballistic protection provided. By forming the desired angle γ between the fibers 16 in respective layers of plies 12 containing a plurality of unidirectional fibers in a fibrous network 14, the composite of the present invention causes a projectile to be thrown or turned from its trajectory. A trajectory is a highly ordered kinetic path, and targets are generally destroyed by the release of the kinetic energy where the projectile strikes.

Preferably, the angle γ is less than about 45°. In the particularly preferred embodiments, the angle γ is less than about 25°. In the more particularly preferred embodiments, the angle γ is less than about 10°. Amongst those particularly preferred embodiments, most preferred are those embodiments in which the angle γ is less than about 4°. In the practice of this invention, the angle γ of choice is between about 1° to about 3°.

The “web” created by the angular offset between the respective layers of plies 12 destabilizes the projectile on impact. This acts to increase the drag action on the projectile 5 and therefore results in kinetic energy transfer from the projectile which degrades the lethality of the projectile. By angularly offsetting fibers 16 at the desired angle γ between adjoining ply layers, the ply layers of the composite 20 of the present invention alter the penetrating projectile's trajectory and reduce the projectile's energy. The angularly offset fibers 16 of successive adjoining ply layers continue to rotate the projectile 5 and dissipate its energy. Additionally, because of the angular offset of the fibers 16 of the adjoining ply 12 layers, a projectile striking the fibrous armor composite 20 of the ballistic resistant article 10 will transfer, or radiate, energy along the angularly offset fibers 16 of the successive ply 12 layers of the composite 20 which results in the dispersion of energy over a large surface area.

Referring to FIG. 4, the example of the fibrous armor composite 20, suitable for use in construction of the ballistic resistant article 10, includes seven stacked layers of fibrous plies 12a-12g. The second layer, 12b, is rotated at an angle γ₁ relative to the first layer, 12a. Similarly, the third layer, 12c, is rotated at an angle γ₂ relative to the second layer, 12b. The fourth layer, 12d, is rotated at an angle γ₃ relative to the third layer, 12c. The fifth layer, 12e, is rotated at an angle γ₄ relative to the fourth layer, 12d. The sixth layer, 12f, is rotated at an angle γ₅ relative to the fifth layer, 12e. Finally, the seventh layer, 12g, is rotated at an angle γ₆ relative to the sixth layer, 12f. As one skilled in the art will appreciate, multiple layers of the fibrous plies 12 can be applied in like fashion until the desired degree of impact resistance is achieved.

Another example of the fibrous armor composite 20 has the second, third, fourth, fifth and sixth layers rotated +10°;−5°;+5°;0° and −10° with respect to the first layer, but not necessarily in that order. Another example would have the second, third, fourth, fifth and sixth layers rotated +2°;0°; −2°;0° and +2° with respect to the first layer, but not necessarily in that order. In yet another example, the second, third, fourth, fifth and sixth layers would be rotated +3°;+6°;+9°;+12 and +15° with respect to the first layer, but not necessarily in that order. It should be clear that there is no requirement that the angle γ used between successive layers of the fibrous plies 12 be consistent throughout the buildup of the layers of the composite 20. Further, there is no requirement that the successive layers of the fibrous plies 12 be rotated in the same direction, i.e., there is no requirement that successive layers of the fibrous plies 12 be rotated clockwise or counter clockwise relative to the previously applied layer. For example, it is contemplated that a second layer of fibrous ply 12 may be rotated clockwise relative to the first layer of fibrous ply 12 an angular offset, a third layer of fibrous ply 12 rotated counter-clockwise to the second layer of fibrous ply 12 by an angular offset, and so forth, until the desired number of layers of the fibrous plies 12 are applied.

The number of layers of the fibrous plies 12 included in the fibrous armor composite 20 may vary widely depending on the uses of the article 10, for example, in those uses where the article 10 would be used as ballistic protection, the number of layers of the fibrous plies 12 would depend on a number of factors including the degree of ballistic protection desired and other factors known to those of skill in the ballistic protection art. In general for this application, the greater the degree of protection desired the greater the number of layers of the fibrous plies 12 included in the composite 20. Conversely, the lessor the degree of ballistic protection required, the lessor the number of layers of fibrous plies 12 included in the composite 20. In the fibrous armor composite 20 of the invention, the number of layers of fibrous plies 12 preferably is between 2 and about 120, more preferably between 2 and about 60; and most preferably between 2 and about 40.

As one skilled in the art will appreciate, a surface of each fibrous ply 12 is in contact with and at least partially bound to the surface of one adjacent fibrous ply 12. The fibrous plies 12 may be secured together in any conventional manner including, but not limited to bolts, rivets, adhesive, staples, stitches, thermal bonding, welding, autoclaving and the like, or combinations thereof. Once the fibrous plies 12 are secured together the fibrous networks 14 within the respective fibrous plies 12 are maintained in desired orientation to each other. For example, a fibrous ply 12 may be bonded to an adjacent fibrous ply 12 through the use of an appropriate adhesive. In another example, the layers of the fibrous plies 12 may be arranged as desired and the composite stitched together to maintain the respective fibrous plies 12 in proper orientation. Alternatively, in an example which exemplifies the use of a combination of securing means, in addition to using an adhesive between the adjoining layers of the plies 12, the plies 12 of the composite 20 may be further secured by stitching.

If stitching is used, the type of stitching employed may vary widely. Stitching and sewing methods such as lock stitching, chain stitching, zig-zag stitching and the like are illustrative of the type of stitching for use in this invention. Useful threads for stitching may vary widely. However, exemplified threads would include those fibers 16 that are described in more detail herein for use in the fabrication of fibrous plies 12. However, the thread used in stitching is preferably an aramid fiber or thread (as for example Kevlar® 29, 49, 129 and 149 aramid fibers), an extended chain polyethylene thread or fiber (as for example Spectra®900 and Spectra® 1000 polyethylene fibers) or a mixture thereof.

As one skilled in the art will appreciate, all that is required within the ply 12 is one plurality of unidirectional oriented fibers 16. If the ply 12 has multiple layers of fibrous networks 14, it can still be used effectively in the practice of the invention since it is still possible to angularly offset, by the angle γ less than 45°, the fibers 16 of at least one plurality of unidirectional oriented fibers within one ply 12 relative to the fibers 16 of a plurality of unidirectional oriented fibers within the adjoining ply 12.

In one example, depicted in FIGS. 5 and 6, each fibrous ply 12a, 12b has a plurality of unidirectional oriented fibers 16a, 16b that form a single fibrous network 14a, 14b. In this example, the fibers 16a, 16b of the pluralities of unidirectional oriented fibers of the joined plies 12 are angularly offset to each other by an angle γ which is less than 45°. In another example, depicted in FIGS. 7 and 8, each fibrous ply 12a, 12b has a pair of fibrous networks 14a, 14b, 14a′, 14b′, the adjacent fibrous networks 14a, 14b,14a′, 14b′ arranged at about a 90° angle with respect to the common axis C1, C1′, C2, C2′ of the fibers 16a, 16b, 16a′, 16b+ contained in the pair of networks 14a, 14b, 14a′, 14b′. In this example, each plurality of unidirectional oriented fibers of one ply 12 is angularly offset by an angle γ₁, γ₂ less than 45° to a plurality of unidirectional oriented fibers in the adjoining ply 12.

Commercial examples of exemplary plies 12 suitable for use with the fibrous armor composite 20 of this invention include Kevlar® 129, an aramid fiber ply manufactured by E. I. DuPont de Nemours and Company, Twaron®, Spectra Shield®, Spectra Shield Plus®, and Gold Flex®. Spectra Shield®, Spectra Shield Plus®, and Gold Flex® are a polymetric ply, having high molecular weight polyethylene fibers in a flexible resin matrix, manufactured by Honeywell. If multiple fibrous networks 14 are used, as for example in the Kevlar® 129 aramid fiber woven ply or the Spectra Shield® ply mentioned above, the fibers 16 within each ply 12 are typically oriented 0°, 45° or 90° to each other (the fibers 16 being either woven or cross-plied to form the desired layout of fibers by methods known to those skilled in the art). Most commonly, the fibers 16 are oriented at 90° to each other.

The fibrous armor composites 20 of this invention can be used in the fabrication of penetration resistance articles and the like using conventional methods. The fibrous armor composite 20 is particularly useful in construction of ballistic resistant articles such as “bulletproof” lining for example because of its enhanced ballistic resistance.

For purposes of the present invention, fiber 16 is defined as an elongated body, the length dimension of which is much greater than the dimensions of width and thickness. Accordingly, the term fiber 16 as used herein includes a monofilament elongated body, a multifilament elongated body, ribbon, strip, and the like having regular or irregular cross sections. The term fibers 16 includes a plurality of any one or combination of the above. The cross-sections of fibers 16 for use in this invention may vary widely. They may be of circular, oblong, or irregular or regular multi-lobal cross-section having one or more regular or irregular lobes projecting from the linear or longitudinal axis of the fiber 16. In the particularly preferred embodiments of the invention, the fibers 16 are of substantially circular or oblong cross-section and in the most preferred embodiments have circular or substantially circular cross-section.

In the plies 12 used to form the fibrous armour composite 20 of the ballistic resistant article 10, the fibers 16 may be arranged in fibrous networks 14. In each network 14, the fibers 16 are arranged so that there are a plurality of fibers 16 that are aligned substantially parallel and unidirectionally along a common fiber direction C (the plurality of unidirectionally oriented fibers 16). The fibers 16 may be formed as a felt, knitted or woven (plain, basket, satin and crow feet weaves, etc.) into a network 14, fabricated into non-woven fabric, arranged in parallel array, layered, or formed into a ply or composite by any of a variety of conventional techniques. Among these techniques, for ballistic resistance applications we prefer to use those variations commonly employed in the preparation of aramid fabrics or plies for ballistic-resistant articles. For example, the techniques described in U.S. Pat. No. 4,181,768 and in M. R. Silyquist et al., J. Macromol Sci. Chem., A7(1), pp. 203 et. seq. (1973), are particularly suitable.

The fibrous network 14 may be formed from fibers 16 alone, or from fibers 16 coated with a suitable polymer, as for example, a polyolefin, polyamide, polyester, polydiene such as a polybutadiene, urethanes, diene/olefin copolymers such as poly(styrene-butadiene-styrene) block copolymers, and a wide variety of elastomers. The network 14 of a fibers 16 may also comprise oriented fibers 16 dispersed in a polymeric matrix material, as for example a matrix material of one or more of the above referenced polymers to form a ply as described in more detail in U.S. Pat. Nos. 4,623,574; 4,748,064; 4,916,000; 4,403,012; 4,457,985; 4,650,710; 4,681,792; 4,737,401; 4,543,286; 4,563,392; and 4,501,856, hereinafter incorporated by reference to the extent that they are not inconsistent.

The type of fibers 16 which are useful in the plies 12 of this invention may vary widely and can be metallic fibers, semi-metallic fibers, inorganic fibers and/or organic fibers. Exemplary fibers 16 include those having a tenacity equal to or greater than about 8 grams per denier (g/d), a tensile modulus equal to or greater than about 150 g/d and an energy-to-break equal to or greater than about 7 joules/gram (j/g). Tensile properties can be evaluated as known in the art, for example, by pulling a 10 inch (25.4 cm) filer length clamped in barrel clamps at a rate of 10 in./minute of an Instron Tensile Testing Machine. Preferred fibers 16 are those having a tenacity at least about 10 g/d, more preferably at least about 15 g/d, and most preferably at least about 25 g/d; a tensile modulus at least about 300 g/d, more preferably at least above 400 g/d, and most preferably at least about 500 g/d; and an energy-to-break at least about 15 j/g, more preferably at least above 20 j/g, and most preferably at least above 30 j/g.

Useful inorganic fibers 16 include S-glass fibers, E-glass fibers, silicon carbide fibers, asbestos fibers, basalt fibers, carbon fibers, boron fibers, alumina fibers, zirconia-silica fibers, alumina-silica fibers, quartz fibers, ceramic fibers, and the like. Exemplary of useful metallic or semi-metallic fibers 16 are those composed of boron, aluminum, steel and titanium.

Illustrative of useful organic fibers 16 are those composed of thermosetting resins, thermoplastics polymers and mixture thereof such as polyesters, polyolefins, polyetheramides, fluoropolymers, polyethers, celluloses, phenolics, polyesteramides, polyurethanes, epoxies, aminoplastics, polysulfones, polyetherketones, polyetheretherketones, polyesterimides, polyphenylene sulfides, polyether acryl ketones, poly(amideimides), and polyimides. Illustrative of other useful organic fibers are those composed of aramids (aromatic polyamides), such as poly(m-xylylene adipamide), poly(p-xylylene sebacamide), poly 2,2,2-trimethylhexamethylene terephthalamide), poly(piperazine sebacamide), poly(metaphenylene isophthalamide) (Nomex®) and poly(p-phenylene terephthalamide) (Kevla®); aliphatic and cycloaliphatic polyamides, such as the copolyamide of 30% hexamethylene diammonium isophthalate and 70% hexamethylene diammonium adipate, the copolyamide of up to 30% bis-(-amidocyclohexyl)methylene, terephthalic acid and caprolactam, polyhexamethylene adipamide (nylon 66), poly(butyrolactam) (nylon 4), poly (9-aminonoanoic acid) (nylon 9), poly(enantholactam) (nylon 7), poly(capryllactam) (nylon 8), polycaprolactam (nylon 6), poly(p-phenylene terephthalamide), polyhexamethylene sebacamide (nylon 6,10), polyaminoundecanamide (nylon 11), polydodeconolactam (nylon 12), polyhexamethylene isophthalamide, polyhexamethylene terephthalamide, polycaproamide, poly(nonamethylene azelamide) (nylon 9,9), poly(decamethylene azelamide) (nylon 10,9), poly(decamethylene sebacamide) (nylon 10,10), poly[bis-(4-aminocyclothexyl)methane 1,10-decanedicarboxamide] (Qiana) (trans), or combination thereof; and aliphatic, cycloaliphatic and aromatic polyesters such as poly(1,4-cyclohexlidene dimethyl eneterephathalate) cis and trans, poly(ethylene-1,5-naphthalate), poly(ethylene-2,6-naphthalate), poly(1,4-cyclohexane dimethylene terephthalate) (trans), poly(decamethylene terephthalate), poly(ethylene terephthalate), poly(ethylene isophthalate), poly(ethylene oxybenozoate), poly(para-hydroxy benzoate), poly(dimethylpropiolactone), poly(decamethylene adipate), poly(ethylene succinate), poly(ethylene azelate), poly(decamethylene sebacate), poly(.beta.,.beta.-dimethyl-propiolactone), and the like.

Also illustrative of useful organic fibers 16 are those of liquid crystalline polymers. Exemplified liquid crystalline polymers are disclosed for example, in U.S. Pat. Nos. 3,975,487; 4,118,372, 4,161,470, and 5,667,029, hereby incorporated by reference.

Also illustrative of useful organic fibers 16 for use in the present invention are those composed of extended chain polymers formed by polymerization of α, β-unsaturated monomers of the formula R₁R₂−C=CH₂, wherein R₁, and R₂ are the same or different and are hydrogen, hydroxy, halogen, alkylcarbonyl, carboxy, alkoxycarbonyl, heterocycle or alkyl or aryl either unsubstituted or substituted with one or more substituents selected from the group consisting of alkoxy, cyano, hydroxy, alkyl and aryl. For greater detail of such polymers of α,β-unsaturated monomers, see U.S. Pat. Nos. 4,916,000 and 5,667,029, hereby incorporated by reference.

In one example, the fiber network 14 may include a high molecular weight polyethylene fiber, a high molecular weight polypropylene fiber, an aramide fiber, a high molecular weight polyvinyl alcohol fiber, a high molecular weight polyacrylonitrile fiber or mixtures thereof. U.S. Pat. Nos. 4,457,985 and 5,677,029 generally discuss such high molecular weight polyethylene and polypropylene fibers, and the disclosure of these patents are hereby incorporated by reference to the extent that they are not inconsistent herewith.

In regard to polyethylene, suitable fibers 16 are those of molecular weight of at least 150,000, preferably at least 300,000, more preferably at least one million and more preferably still, between two million and five million. Such extended chain polyethylene (ECPE) fibers may be grown in solution as described in U.S. Pat. No. 4,137,394 or U.S. Pat. No. 4,356,138, or may be a fiber spun from a solution to form a gel structure, as described in German Off. 3,004,699 and GB 2051667, and especially described in U.S. Pat. No. 4,413,110 and 4,551,296, also hereby incorporated by reference. Other high strength polyethlyene fibers and techniques known for forming such fibers, including variations of the above techniques, can also be used in accordance with the present invention. Depending upon the formation technique, a variety of properties can be imparted to the fibers 16.

The previously described highest values for tenacity, modulus and energy-to-break are generally obtainable by employing these solution grown or gel fiber processes. An example of a useful high strength fiber 16 is an extended chain polyethylene known as Spectra® which is commercially available from Honeywell, Inc. As used herein, the term polyethylene refers to predominantly linear polyethylene materials that may contain minor amounts of chain branching or comonomers not exceeding 5 modifying units per 100 main chain carbon atoms, and that may also contain admixed therewith not more than about 50 weight percent of one or more polymeric additives such as alkene-1-polymers, in particular, low density polyethylene, polypropylene or polybutylene, copolymers containing mono-olefins as primary monomers, oxidized polyolefins, graft polyolefin copolymers and polyoxymethylenes, or low molecular weight additives such as anti-oxidants, lubricants, ultra-violet screening agents, colorants and the like which are commonly incorporated by reference.

Similarly, highly oriented polypropylene fibers of molecular weight at least 200,000, preferably at least one million and more preferably at least two million, may be used. Such high molecular weight polypropylene may be formed into reasonably well oriented fibers by the techniques prescribed in the various references referred to above, and especially by the technique of U.S. Pat. Nos. 4,663,101 and 4,784,820 and published application WO 89 00213. Since polypropylene is a much less crystalline material than polyethylene and contains pendant methyl groups, tenacity values achievable with polypropylene are generally substantially lower than the corresponding values for polyethylene. Accordingly, a suitable tenacity is at least 8 g/d, preferably at least 11 g/d, and more preferably is at least 15 g/d. The tensile modulus (as measured by an Instron Tensile Testing Machine) for polypropylene is at least about 150 g/d, preferably at least about 200 g/d, more preferably at least about 200 g/d, and most preferably at least about 300 g/d. The energy-to-break of the polypropylene is at least about 8 j/g, preferably at least about 40 j/g, and most preferably at least about 60 j/g.

Useful aramid fibers 16 are formed principally from aromatic polyamide and are described in U.S. Pat. No. 3,671,542, which is hereby incorporated by reference. Preferred aramid fibers 16 preferably have a tenacity of at least about 20 g/d; a tensile modulus preferably of at least about 400 g/d, more preferably of at least about 480 g/d, and most preferably of at least 900 g/d; and an energy-to-break of at least about 8 j/g, more preferably of at least about 20 joules/gram, and most preferably of at least about 30 j/g. For example, poly(phenylene terephthalamide) fibers produced commercially by Dupont Corporation under the trade name of Kevlar® are useful. Also useful in the practice of this invention is poly(metaphenylene isophthalamide) fibers produced commercially by Dupont under the tradename Nomex®.

High molecular weight polyvinyl alcohol fibers 16 having high tensile modulus are described in U.S. Pat. No. 4,440,711, which is hereby incorporated by reference to the extent it is not inconsistent herewith. Preferred polyvinyl alcohol fibers 16 will have a tenacity of at least about 10 g/d, a modulus of at least about 200 g/d, and an energy-to-break of at least about 8 j/g. Particularly preferred polyvinyl alcohol fibers 16 will have a tenacity of at least about 15 g/d , a modulus of at least about 300 g/d, and an energy-to-break of at least about 25 j/g. Most preferred polyvinyl alcohol fibers 16 will have a tenacity of at least about 20 g/d, a modulus of at least about 500 g/d, and an energy-to-break of at least about 30 j/g. Suitable polyvinyl alcohol fiber 16 of molecular weight of at least about can be produced, for example, by the process disclosed in U.S. Pat. No. 4,599,267.

In regard to polyacrylonitrile (PAN) fiber, PAN fibers for use in the present invention have a molecular weight of at least about 400,000. Particularly useful PAN fibers should have a tenacity of at least about 10 g/d and an energy-to-break of at least about 8 j/g. PAN fibers having a molecular weight of at least about 400,000, a tenacity of at least about 15 to about 20 g/d and an energy-to-break of at least 8 j/g is useful in producing ballistic resistant plies; and such fibers are disclosed, for example, in U.S. Pat. No. 4,535,027.

Exemplary suitable commercially available high strength fibers 16 include: Vectran®; Trevar®; and Certran® from Hoechst Celanese Corporation of Charlotte, N.C.; Kelvar® from DuPont of Wilmington, Del.; Spectra® from Honeywell Corporation; Dymemma® from DSM Corporation of Heerlen, The Netherlands; Twaron® from Akzo Nobel of Arnhem, The Netherlands; Technora® from Osaka and Tokyo, Japan.

The fibers 16, for example, may be precoated with a suitable polymer, such as a low modulus or high modulus elastomer material prior to being arranged in the network. A wide variety of suitable coating materials and techniques for coating fibers using the same are well known in the art, for example, as described in U.S. Pat. Nos., 4,650,710, 4,737,401, and 5,124,195.

Any of the known matrix materials can be used in manufacturing the ply 12 of the invention, for example by coating the ply 12 with a matrix material. The matrix material may be flexible (low modulus) or rigid (high modulus). A wide variety of matrix materials and techniques are known to those skilled in the art, for example, those described in U.S. Pat. Nos. 4,916,000 and 5,677,029. The proportions of matrix material to fiber 16 in the ply 12 is not critical and may vary widely depending on a number of factors including, whether the matrix material has any ballistic-resistant properties of its own (which is generally not the case) and upon the rigidity, shape, heat resistance, wear resistance, flammability resistance and other properties desired for the composite article. In general, the proportion of matrix to fiber 16 in the composite may vary from relatively small amounts where the amount of matrix is about 10% by volume of the fibers to relatively large amounts where the amount of matrix is up to about 90% by volume of the fibers. In the preferred plies 12, matrix amounts of from about 15 to about 80% by volume are employed. All volume percents are based on the total volume of the ply 12. The fibrous armor composite 20 may contain a relatively minor proportion of the matrix (e.g., about 10 to about 30% by volume), since the ballistic-resistant properties are almost entirely attributable to the fiber 16. The proportion of the matrix in the composite 20 is from about 10 to about 30% by weight of fibers 16.

It will be apparent to those skilled in the art that various modifications and variations can be made in the present invention without departing from the scope or spirt of the invention. Other embodiments of the invention will be apparent to those skilled in the art from consideration of the specification and practice of the invention disclosed herein. It is intended that the specification and examples be considered as exemplary only, with a true scope and spirt of the invention being indicated by the following claims.

What is claimed is:

1. A ballistic resistant article comprising:
a) at least one hard armor layer; and
b) at least one fibrous armor composite layer, each fibrous composite layer comprising two or more fibrous plies, each ply having at least one fibrous network and a surface, each fibrous network having a plurality of unidirectional oriented fibers, wherein the fibers of each fibrous network are arranged substantially parallel to one another along a common fiber direction within the fibrous network, wherein the fibers of one fibrous network of one fibrous ply are at an angle of less than 45° to the fibers of one fibrous network of the adjacent fibrous ply, and wherein the surface of one fibrous ply is in contact with and at least partially bound to the surface of one adjacent fibrous ply.

2. The article of claim 1, wherein there are from 2 to 80 fibrous plies.

3. The article of claim 1, wherein there are from 2 to 40 fibrous plies.

4. The article of claim 1, wherein the angle is less than 25°.

5. The article of claim 1, wherein the angle is less than 10°.

6. The article of claim 1, wherein the angle is less than 4°.

7. The article of claim 1, wherein the fibers are polyethylene fibers, nylon fibers, aramid fibers or mixtures thereof.

8. The article of claim 1, wherein the fibers are selected from a group consisting of: metallic fibers, semi-metallic fibers, inorganic fibers, organic fibers or mixtures thereof.

9. The article of claim 1, wherein the fibers are embedded in a matrix material.

10. The article of claim 1, wherein the fibrous ply comprises a non-woven ply.

11. The article of claim 1, wherein the fibrous ply comprises a woven ply.

12. The article of claim 1, wherein the network of oriented fibers comprises a sheet-like fiber array.

13. The article of claim 1, wherein each fibrous ply has two fibrous networks, wherein adjacent fibrous networks are at a 90° angle with respect to the longitudinal axis of the fibers contained within the networks.

14. The article of claim 1, wherein each fibrous ply has two fibrous networks, wherein adjacent fibrous networks are at about a 90° angle with respect to the longitudinal axis of the fibers contained within the networks.

15. The article of claim 1, wherein the hard armor layer is selected from the group consisting of: a metal, a metal/ceramic composite, a ceramic, a hardened polymer or combinations thereof.

16. The article of claim 1, wherein the hard armor layer is positioned on the impact side of the article exposed to a threat.

17. The article of claim 1, wherein the fibrous armor composite layer is positioned on the impact side of the article exposed to a threat.

18. A ballistic resistant article comprising:
a) a hard armor layer; and
b) a fibrous armor composite layer comprising two or more fibrous plies, each ply having a surface and a plurality of unidirectional oriented fibers, wherein the fibers in adjacent fibrous plies are at an angle of less than 45° to each other, and wherein the surface of one fibrous ply is in contact with and at least partially bound to the surface of one adjacent fibrous ply.

19. The article of claim 18, wherein each fibrous ply has a sheet-like fiber array in which the fibers are arranged substantially parallel to one another along a common longitudinal fiber direction.

20. The article of claim 18, wherein each fibrous ply has a pair of sheet-like fiber arrays in which adjacent arrays are aligned at an angle about 90° with respect to the common fiber direction of the parallel fibers contained in the adjacent array.

21. The article of claim 18, wherein there are from 2 to 80 plies.

22. The article of claim 18, wherein there are from 2 to 40 plies.

23. The article of claim 18, wherein the angle is less than 25°.

24. The article of claim 18, wherein the angle is less than 10°.

25. The article of claim 18, wherein the angle is less than 4°.

26. The article of claim 18, wherein the fibers are polyethylene fibers, nylon fibers, aramid fibers or mixtures thereof.

27. The article of claim 18, wherein the fibers are selected from a group consisting of: metallic fibers, semi-metallic fibers, inorganic fibers, organic fibers or mixtures thereof.

28. The article of claim 18, wherein the fibers are embedded in a matrix material.

29. The article of claim 18, wherein the fibrous ply comprises a non-woven ply.

30. The article of claim 18, wherein the fibrous ply comprises a woven ply.

31. The article of claim 18, wherein the hard armor layer is selected from the group consisting of: a metal, a metal/ceramic composite, a ceramic, a hardened polymer or combinations thereof.

32. The article of claim 18, wherein the hard armor layer is positioned on the impact side of the article exposed to a threat.

33. The article of claim 18, wherein the fibrous armor composite layer is positioned on the impact side of the article exposed to a threat.

34. A ballistic resistant article comprising:
a) a hard armor layer positioned on the impact side of the article exposed to a threat; and
b) a fibrous armor composite layer positioned on the non-impact side of the article, the fibrous armor composite layer comprising two or more fibrous plies, each ply having a surface and a plurality of unidirectional oriented fibers, wherein the fibers in adjacent fibrous plies are at an angle of less than 45° to each other, and wherein the surface of one fibrous ply is in contact with and at least partially bound to the surface of one adjacent fibrous ply.

35. The article of claim 34, wherein each fibrous ply has a sheet-like fiber array in which the fibers are arranged substantially parallel to one another along a common longitudinal fiber direction.

36. The article of claim 34, wherein each fibrous ply has a pair of sheet-like fiber arrays in which adjacent arrays are aligned at an angle about 90° with respect to the common fiber direction of the parallel fibers contained in the adjacent array.

37. A ballistic resistant article comprising:
a) a hard armor layer positioned on the non-impact side of the article; and
b) a fibrous armor composite layer positioned on the impact side of the article exposed to a threat, the fibrous armor composite comprising two or more fibrous plies, each ply having a surface and a plurality of unidirectional oriented fibers, wherein the fibers in adjacent fibrous plies are at an angle of less than 45° to each other, and wherein the surface of one fibrous ply is in contact with and at least partially bound to the surface of one adjacent fibrous ply.

38. The article of claim 37, wherein each fibrous ply has a sheet-like fiber array in which the fibers are arranged substantially parallel to one another along a common longitudinal fiber direction.

39. The article of claim 37, wherein each fibrous ply has a pair of sheet-like fiber arrays in which adjacent arrays are aligned at an angle about 90° with respect to the common fiber direction of the parallel fibers contained in the adjacent array.
